(19) United States
(12) Patent Application Publication
(10) Pub. No.: US 2026/0121470 A1
(43) Pub. Date: Apr. 30, 2026

(54) MAGNETIC LEVITATION MOTOR

(71) Applicant: National University Corporation Gunma University, Gunma (JP)

(72) Inventor: Nobuyuki Kurita, Gunma (JP)

(21) Appl. No.: 18/847,996

(22) PCT Filed: Mar. 22, 2023
(86) PCT No.: PCT/JP2023/011312

§ 371 Date: Sep. 17, 2024

(30) Foreign Application Priority Data
Mar. 30, 2022 (JP) 2022-057372

(51) Int. Cl. H02K 1/2796; H02K 1/14

(52) U.S. Cl. CPC H02K 1/2796; H02K 1/14

(57) ABSTRACT

In a magnetic levitation motor, an attraction force toward a one-side stator acts on a rotor and an attraction force toward an other-side stator acts on the rotor, whereby the rotor levitates between the one-side stator and the other-side stator. Additionally, a supply of current to coils of the other-side stator is controlled such that magnetic poles of one-side surfaces of salient poles of the other-side stator are controlled, whereby the rotor is rotated. Here, the one-side stator is provided with just a permanent magnet and is not provided with a coil. For this reason, the configuration can be simplified.

### TECHNICAL FIELD

The present invention relates to a magnetic levitation motor where a rotor is disposed between a one-side stator and an other-side stator.

### BACKGROUND ART

In the axial-type magnetic levitation motor described in Japanese Patent No. 5,963,134, a one-side stator is disposed on one side in an axial direction of a rotor, and an other-side stator is disposed on another side in the axial direction of the rotor.

Here, in this axial-type magnetic levitation motor, an one-side surface and an other-side surface of the rotor in the axial direction thereof are provided with permanent magnets, and the one-side stator and the other-side stator are provided with coils. Additionally, the magnetic flux generated by the coils of the one-side stator and the magnetic flux generated by the coils of the other-side stator are controlled such that the rotor is rotated in its circumferential direction, and a displacement force in a radial direction acts on the rotor.

### SUMMARY OF INVENTION

### Technical Problem

In consideration of the above circumstances, it is an object of the present invention to obtain a magnetic levitation motor whose configuration can be simplified.

### Solution to Problem

A magnetic levitation motor of a first aspect of the present invention comprises: a rotor that is rotatable in a circumferential direction; a one-side stator that is disposed at one side in an axial direction of the rotor; an other-side stator that is disposed at another side in the axial direction of the rotor and that is provided with a coil; a rotating permanent magnet that is provided at an axial direction other-side portion of the rotor and that is attracted to the other-side stator such that the rotor is attracted toward the other side in the axial direction, with magnetic flux generated by the coil being controlled such that the rotor is rotated; and an attracting permanent magnet that is provided at at least one of an axial direction one-side portion of the rotor or the one-side stator such that an attracting magnetic path is formed between the rotor and the one-side stator, whereby the rotor is attracted toward the one side in the axial direction, and when the rotor has become displaced in a radial direction, the attracting magnetic path is inclined relative to the axial direction of the rotor.

A magnetic levitation motor of a second aspect of the present invention is the magnetic levitation motor of the first aspect of the present invention, further comprising a rotating opposing portion that is provided at the rotor; and a fixed opposing portion that is provided at the one-side stator and that opposes the rotating opposing portion such that the attracting magnetic path is formed between the rotating opposing portion and the fixed opposing portion, and when the rotor has become displaced in the radial direction, at least part of opposition between the rotating opposing portion and the fixed opposing portion is canceled.

A magnetic levitation motor of a third aspect of the present invention is the magnetic levitation motor of the second aspect of the present invention, wherein an opposing surface of the fixed opposing portion that opposes the rotating opposing portion is disposed along an opposing surface of the rotating opposing portion that opposes the fixed opposing portion.

A magnetic levitation motor of a fourth aspect of the present invention is the magnetic levitation motor of any one of the first aspect to the third aspect of the present invention, wherein the attracting magnetic path is formed at the entire circumferential direction of the rotor.

A magnetic levitation motor of a fifth aspect of the present invention is the magnetic levitation motor of any one of the first aspect to the fourth aspect of the present invention, wherein a plurality of the attracting magnetic paths are formed at the radial direction of the rotor.

### Advantageous Effects of Invention

In the magnetic levitation motor of the first aspect of the present invention, the one-side stator is disposed at the one side in the axial direction of the rotor, and the other-side stator is disposed at the other side in the axial direction of the rotor. Furthermore, the attracting permanent magnet is provided at at least one of the axial direction one-side portion of the rotor or the one-side stator, such that the attracting magnetic path is formed between the rotor and the one-side stator, whereby the rotor is attracted toward the one side in the axial direction. Moreover, the rotating permanent magnet is provided at the axial direction other-side portion of the rotor, and the rotating permanent magnet is attracted to the other-side stator such that the rotor is attracted toward the other side in the axial direction. Additionally, the other-side stator is provided with the coil, and the magnetic flux generated by the coil is controlled such that the rotor is rotated.

Here, the one-side stator is not provided with a coil. For this reason, the configuration can be simplified.

Moreover, when the rotor has become displaced in the radial direction, the attracting magnetic path between the rotor and the one-side stator is inclined relative to the axial direction of the rotor. For this reason, a restoring force in the radial direction can be made to act on the rotor.

In the magnetic levitation motor of the second aspect of the present invention, the rotating opposing portion of the rotor and the fixed opposing portion of the one-side stator oppose each other, and the attracting magnetic path is formed between the rotating opposing portion and the fixed opposing portion. Additionally, when the rotor has become displaced in the radial direction, at least part of the opposition between the rotating opposing portion and the fixed opposing portion is canceled. For this reason, the attracting magnetic path can be inclined relative to the axial direction of the rotor.

In the magnetic levitation motor of the third aspect of the present invention, the opposing surface of the fixed opposing portion that opposes the rotating opposing portion is disposed along the opposing surface of the rotating opposing portion that opposes the fixed opposing portion. For this reason, the force with which the rotating opposing portion is attracted to the fixed opposing portion can be increased.

In the magnetic levitation motor of the fourth aspect of the present invention, the attracting magnetic path is formed at the entire circumferential direction of the rotor. For this reason, the force with which the rotor is attracted to the one-side stator can be increased.

In the magnetic levitation motor of the fifth aspect of the present invention, a plurality of the attracting magnetic paths are formed at the radial direction of the rotor. For this reason, the force with which the rotor is attracted to the one-side stator can be increased.

### BRIEF DESCRIPTION OF DRAWINGS

FIG. 1 is a perspective view showing a magnetic levitation motor pertaining to a first embodiment of the present invention.

FIG. 2A is a plan view showing a stator core of an other-side stator and rotor magnets of a rotor when the rotor is rotated in the magnetic levitation motor pertaining to the first embodiment of the present invention.

FIG. 2B is a plan view showing the stator core of the other-side stator and the rotor magnets of the rotor when a displacement force toward one side acts on the rotor in the magnetic levitation motor pertaining to the first embodiment of the present invention.

FIG. 2C is a plan view showing the stator core of the other-side stator and the rotor magnets of the rotor when a tilting force about an X-axis direction acts on the rotor in the magnetic levitation motor pertaining to the first embodiment of the present invention.

FIG. 2D is a plan view showing the stator core of the other-side stator and the rotor magnets of the rotor when a tilting force about a Y-axis direction acts on the rotor in the magnetic levitation motor pertaining to the first embodiment of the present invention.

FIG. 3 is a perspective view showing a one-side stator and the rotor in the magnetic levitation motor pertaining to the first embodiment of the present invention.

FIG. 4A is a cross-sectional view showing the one-side stator and a rotating body of the rotor during normal operation in the magnetic levitation motor pertaining to the first embodiment of the present invention.

FIG. 4B is a cross-sectional view showing the one-side stator and the rotating body of the rotor when the rotor is displaced in the radial direction in the magnetic levitation motor pertaining to the first embodiment of the present invention.

FIG. 5 is a cross-sectional view showing the one-side stator and the rotating body of the rotor in a magnetic levitation motor pertaining to an example modification (a first example modification) of the first embodiment of the present invention.

FIG. 6 is a cross-sectional view showing the one-side stator and the rotating body of the rotor in a magnetic levitation motor pertaining to a second embodiment of the present invention.

FIG. 7 is a cross-sectional view showing the one-side stator and the rotating body of the rotor in a magnetic levitation motor pertaining to an example modification (a second example modification) of the second embodiment of the present invention.

FIG. 8 is a cross-sectional view showing the one-side stator and the rotating body of the rotor in a magnetic levitation motor pertaining to a third embodiment of the present invention.

FIG. 9 is a cross-sectional view showing the one-side stator and the rotating body of the rotor in a magnetic levitation motor pertaining to a fourth embodiment of the present invention.

FIG. 10 is a cross-sectional view showing the one-side stator and the rotating body of the rotor in a magnetic levitation motor pertaining to an example modification (a third example modification) of the fourth embodiment of the present invention.

### DESCRIPTION OF EMBODIMENTS

### First Embodiment

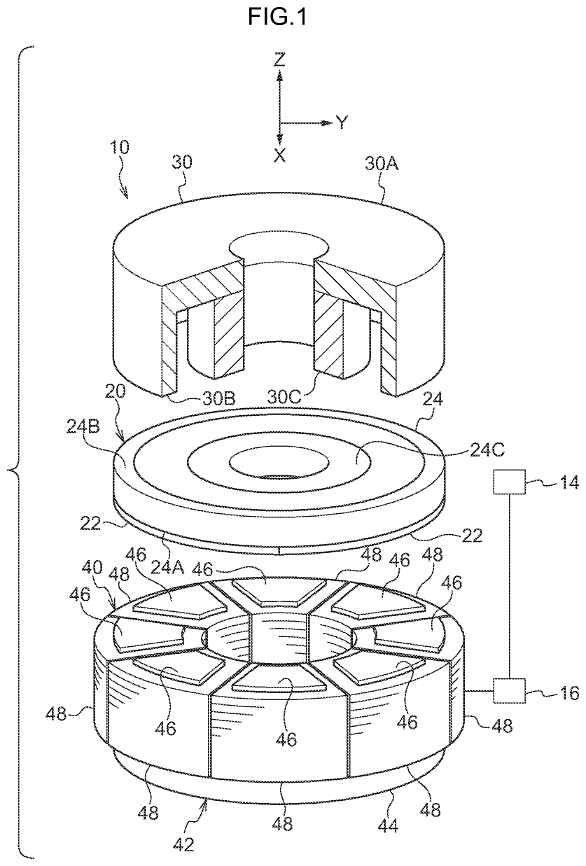

In FIG. 1, a magnetic levitation motor 10 pertaining to a first embodiment of the present invention is shown in a perspective view. It will be noted that in the present embodiment the position of the magnetic levitation motor 10 is indicated by a coordinate system with an X-axis, a Y-axis, and a Z-axis, and in the drawings the X-axis positive direction of the magnetic levitation motor 10 is indicated by arrow X, the Y-axis positive direction of the magnetic levitation motor 10 is indicated by arrow Y, and the Z-axis positive direction of the magnetic levitation motor 10 is indicated by arrow Z.

On the outer periphery of the magnetic levitation motor 10 pertaining to the present embodiment is provided a container-shaped housing (not shown in the drawings).

As shown in FIG. 1, inside the housing is provided a substantially disk-shaped rotor 20, and the rotor 20 is rotatable in its circumferential direction, displaceable in its axial direction (Z-axis direction) and radial direction (X-axis direction and Y-axis direction, etc.), and tiltable about its radial direction.

On one side (one side in the axial direction, the Z-axis positive direction side) of the rotor 20 is provided a one-side stator 30, on the other side (the other side in the axial direction, the Z-axis negative direction side) of the rotor 20 is provided an other-side stator 40, and the one-side stator 30 and the other-side stator 40 are fixed inside the housing and their central axes are disposed along the Z-axis.

In the other-side stator 40 is coaxially provided a stator core 42 that is a magnetic body serving as a stator body, and on the other-side end portion of the stator core 42 is coaxially provided a substantially disk-shaped stator plate 44. Integrally provided on the stator plate 44 are plural salient poles 46 serving as magnetic pole portions, and the plural salient poles 46 project toward the one side and are arranged at equal intervals in the circumferential direction of the stator plate 44. In the present embodiment, eight salient poles 46A to 46H that are the salient poles 46 are provided, and the salient poles 46A to 46H are each formed in a substantially trapezoidal prism shape and are arranged in this order in the circumferential direction of the stator plate 44. Around the salient poles 46 are wound coils 48, and current is supplied to the coils 48 such that the one-side surfaces of the salient poles 46 are magnetic poles (N-poles or S-poles).

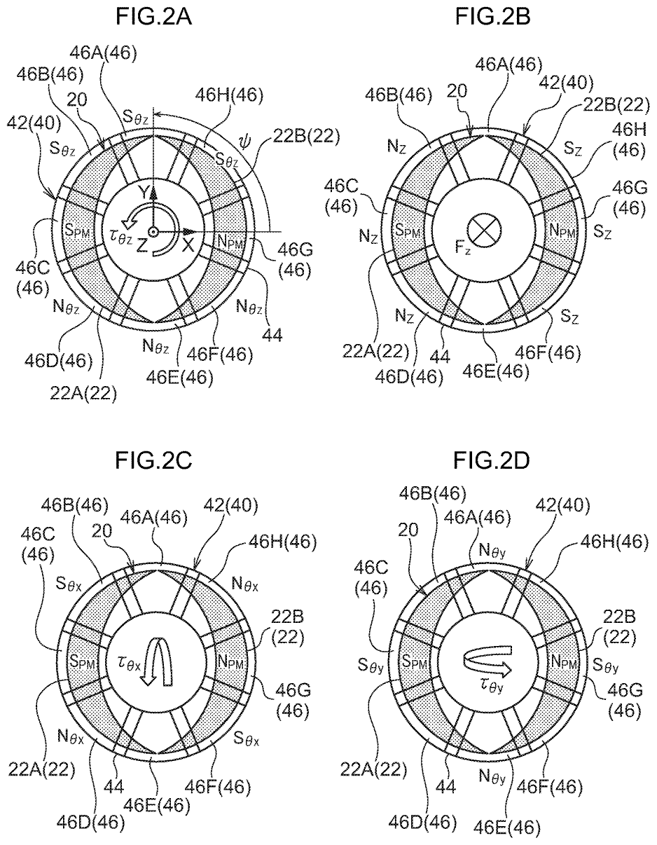

On the other-side surface of the rotor 20 are integrally provided plural rotor magnets 22 that are permanent magnets serving as rotating permanent magnets (see FIG. 2A), and the plural rotor magnets 22 are arranged at equal intervals in the circumferential direction of the rotor 20. In the present embodiment, two rotor magnets 22A and 22B that are the rotor magnets 22 are provided, the rotor magnets 22A and 22B are each formed in a crescent moon shape and are disposed in each semicircular range in the circumferential direction of the rotor 20, and the other-side surfaces of the rotor magnet 22A and the rotor magnet 22B are an S-pole and an N-pole, respectively. An attraction force (magnetic force) toward the salient poles 46 of the other-side stator 40 acts on the rotor magnets 22, whereby an attraction force toward the other side acts on the rotor 20.

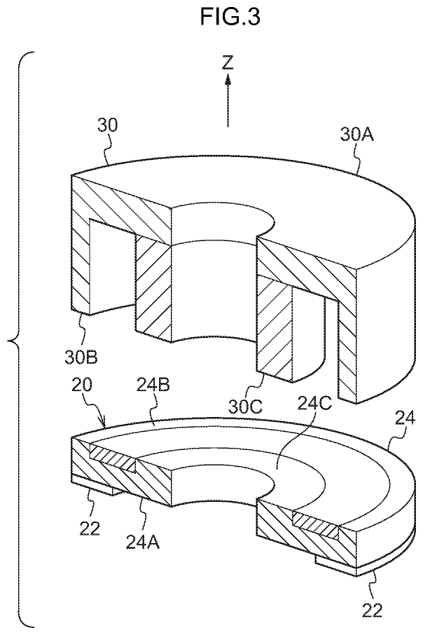

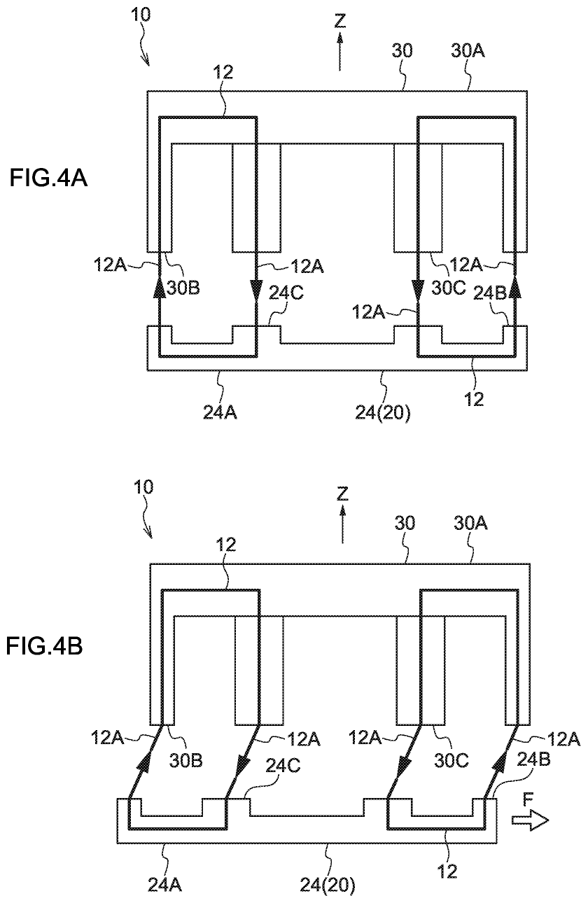

The one-side stator 30 (see FIG. 3 and FIG. 4A) is a magnetic body, and on the one-side end portion of the one-side stator 30 is coaxially provided a substantially disk-shaped fixed plate 30A. On the outer peripheral end portion of the fixed plate 30A is integrally and coaxially provided an open cylinder-shaped outer fixed portion 30B serving as a fixed opposing portion, and the outer fixed portion 30B projects toward the other side and its other-side surface is formed in a planar shape perpendicular to the Z-axis. On the inner peripheral side of the fixed plate 30A is integrally and coaxially provided an open cylinder-shaped inner fixed portion 30C serving as a fixed opposing portion, and the inner fixed portion 30C projects toward the other side and its other-side surface is formed in a planar shape perpendicular to the Z-axis. The radial direction dimension of the circumferential wall of the inner fixed portion 30C is large compared with the radial direction dimension of the circumferential wall of the outer fixed portion 30B, and the area of the other-side surface of the inner fixed portion 30C is identical to the area of the other-side surface of the outer fixed portion 30B. The inner fixed portion 30C is a permanent magnet serving as an attracting permanent magnet, and the inner fixed portion 30C forms a magnetic path 12 passing in the axial direction of the inner fixed portion 30C, the radial direction of the fixed plate 30A, and the axial direction of the outer fixed portion 30B.

In the rotor 20 is coaxially provided a rotating body 24 (see FIG. 3 and FIG. 4A) that is a magnetic body, and on the other-side portion of the rotating body 24 is coaxially provided a substantially disk-shaped rotating plate 24A. On the outer peripheral end portion of the rotating plate 24A is integrally and coaxially provided an open cylinder-shaped outer rotating portion 24B serving as a rotating opposing portion, and the outer rotating portion 24B projects toward the one side and its one-side surface is formed in a planar shape perpendicular to the axial direction of the rotor 20. On the inner peripheral side of the rotating plate 24A is integrally and coaxially provided an open cylinder-shaped inner rotating portion 24C serving as a rotating opposing portion, and the inner rotating portion 24C projects toward the one side and its one-side surface is formed in a planar shape perpendicular to the axial direction of the rotor 20.

The outer diameter and inner diameter of the outer rotating portion 24B are identical to the outer diameter and inner diameter of the outer fixed portion 30B of the one-side stator 30, respectively, and the outer diameter and inner diameter of the inner rotating portion 24C are identical to the outer diameter and inner diameter of the inner fixed portion 30C of the one-side stator 30, respectively. The one-side surface of the outer rotating portion 24B and the one-side surface of the inner rotating portion 24C oppose in the Z-axis direction the other-side surface of the outer fixed portion 30B and the other-side surface of the inner fixed portion 30C, respectively, and the magnetic path 12 formed by the inner fixed portion 30C passes between the one-side surface of the inner rotating portion 24C and the other-side surface of the inner fixed portion 30C and in the radial direction of the rotating plate 24A and between the one-side surface of the outer rotating portion 24B and the other-side surface of the outer fixed portion 30B. Furthermore, the magnetic path 12 passes between the one-side surface of the inner rotating portion 24C and the other-side surface of the inner fixed portion 30C such that an attraction force (magnetic force) toward the other-side surface of the inner fixed portion 30C acts on the one-side surface of the inner rotating portion 24C, and the magnetic path 12 passes between the one-side surface of the outer rotating portion 24B and the other-side surface of the outer fixed portion 30B such that an attraction force (magnetic force) toward the other-side surface of the outer fixed portion 30B acts on the one-side surface of the outer rotating portion 24B, whereby an attraction force toward the one side and the Z-axis side (the side that becomes coaxial with the Z-axis) acts on the rotor 20. It will be noted that the magnetic paths 12 between the one-side stator 30 and the rotating body 24 will hereinafter be called “attracting magnetic paths 12A.”

On the periphery of the rotor 20 is provided a sensor 14 serving as a detection unit, and the sensor 14 detects the rotation of the rotor 20, displacement of the rotor 20 in the axial direction and the radial direction, and tilting of the rotor 20 about the radial direction. The sensor 14 is connected to a control device 16, and the coils 48 of the other-side stator 40 are connected to the control device 16. The control device 16 controls the supply of current to the coils 48 based on the detection results of the sensor 14 to control the magnetic poles of the one-side surfaces of the salient poles 46 of the other-side stator 40.

Next, the action of the present embodiment will be described.

In the magnetic levitation motor 10 with the above configuration, an attraction force toward the salient poles 46 of the other-side stator 40 acts on the rotor magnets 22 of the rotor 20, such that an attraction force toward the other side acts on the rotor 20. Furthermore, attraction forces toward the outer fixed portion 30B and the inner fixed portion 30C of the one-side stator 30 act on the outer rotating portion 24B and the inner rotating portion 24C of the rotor 20 (the rotating body 24), respectively, such that an attraction force toward the one side acts on the rotor 20. For this reason, the rotor 20 levitates between the other-side stator 40 and the one-side stator 30.

Moreover, attraction forces toward the outer fixed portion 30B and the inner fixed portion 30C of the one-side stator 30 act on the outer rotating portion 24B and the inner rotating portion 24C of the rotor 20 (the rotating body 24), respectively, such that an attraction force toward the Z-axis side acts on the rotor 20. For this reason, the entire one-side surface of the outer rotating portion 24B opposes the entire other-side surface of the outer fixed portion 30B in the Z-axis direction, and the entire one-side surface of the inner rotating portion 24C opposes the entire other-side surface of the inner fixed portion 30C in the Z-axis direction, such that the central axis of the rotor 20 is disposed along the Z-axis.

When the rotor 20 is rotated, based on the rotational position of the rotor 20 detected by the sensor 14 the control device 16 controls the supply of current to the coils 48 of the other-side stator 40 to control the magnetic poles of the one-side surfaces of the salient poles 46 of the other-side stator 40, whereby a rotational force acts on the rotor 20.

For example, as shown in FIG. 2A, in a case where the rotor magnet 22A (whose other-side surface is an S-pole) is disposed in a counterclockwise range from the salient pole 46A to the salient pole 46E and the rotor magnet 22B (whose other-side surface is an N-pole) is disposed in a counterclockwise range from the salient pole 46E to the salient pole 46A, the one-side surfaces of the salient pole 46A, the salient pole 46B, and the salient pole 46H are controlled to S-poles and the one-side surfaces of the salient pole 46D, the salient pole 46E, and the salient pole 46F are controlled to N-poles, whereby a counterclockwise rotational force tez acts on the rotor 20.

When the rotor 20 has become displaced in the axial direction, based on the axial direction position of the rotor 20 detected by the sensor 14 the control device 16 controls the supply of current to the coils 48 of the other-side stator 40 to control the magnetic poles of the one-side surfaces of the salient poles 46 of the other-side stator 40, whereby a restoring force in the axial direction acts on the rotor 20 and the displacement of the rotor in the axial direction is eliminated.

For example, as shown in FIG. 2B, when the rotor 20 has become displaced toward the one side, in a case where the rotor magnet 22A (whose other-side surface is an S-pole) is disposed in a counterclockwise range from the salient pole 46A to the salient pole 46E and the rotor magnet 22B (whose other-side surface is an N-pole) is disposed in a counterclockwise range from the salient pole 46E to the salient pole 46A, the one-side surfaces of the salient pole 46B, the salient pole 46C, and the salient pole 46D are controlled to N-poles and the one-side surfaces of the salient pole 46F, the salient pole 46G, and the salient pole 46H are controlled to S-poles, whereby a restoring force Fz toward the other side acts on the rotor 20 and the displacement of the rotor 20 toward the one side is eliminated.

When the rotor 20 has become tilted about the radial direction, based on the tilt position of the rotor 20 about the radial direction detected by the sensor 14 the control device 16 controls the supply of current to the coils 48 of the other-side stator 40 to control the magnetic poles of the one-side surfaces of the salient poles 46 of the other-side stator 40, whereby a restoring force about the radial direction acts on the rotor 20 and the tilting of the rotor 20 about the radial direction is eliminated.

For example, as shown in FIG. 2C, when the rotor 20 has become tilted about the X-axis direction, in a case where the rotor magnet 22A (whose other-side surface is an S-pole) is disposed in a counterclockwise range from the salient pole 46A to the salient pole 46E and the rotor magnet 22B (whose other-side surface is an N-pole) is disposed in a counterclockwise range from the salient pole 46E to the salient pole 46A, the one-side surfaces of the salient pole 46B and the salient pole 46F are controlled to S-poles and the one-side surfaces of the salient pole 46D and the salient pole 46H are controlled to N-poles, whereby a restoring force tex about the X-axis direction acts on the rotor 20 and the tilting of the rotor 20 about the X-axis direction is eliminated.

For example, as shown in FIG. 2D, when the rotor 20 has become tilted about the Y-axis direction, in a case where the rotor magnet 22A (whose other-side surface is an S-pole) is disposed in a counterclockwise range from the salient pole 46A to the salient pole 46E and the rotor magnet 22B (whose other-side surface is an N-pole) is disposed in a counterclockwise range from the salient pole 46E to the salient pole 46A, the one-side surfaces of the salient pole 46A and the salient pole 46E are controlled to N-poles and the one-side surfaces of the salient pole 46C and the salient pole 46G are controlled to S-poles, whereby a restoring force tey about the Y-axis direction acts on the rotor 20 and the tilting of the rotor 20 about the Y-axis direction is eliminated.

Here, in the magnetic levitation motor 10 pertaining to the present embodiment, the one-side stator 30 is provided with just a permanent magnet (the inner fixed portion 30C) and is not provided with a coil. For this reason, the configuration of the one-side stator 30 can be simplified and the need to provide a device that controls current supplied to the coil of the one-side stator 30 can be eliminated, and the configuration of the magnetic levitation motor 10 can be simplified and the magnetic levitation motor 10 can be reduced in size.

Furthermore, as shown in FIG. 4B, when the rotor 20 has become displaced in the radial direction, part of the opposition between the outer rotating portion 24B of the rotor 20 and the outer fixed portion 30B of the one-side stator 30 and part of the opposition between the inner rotating portion 24C of the rotor 20 and the inner fixed portion 30C of the one-side stator 30 are canceled, and the attracting magnetic path 12A between the outer rotating portion 24B and the outer fixed portion 30B and the attracting magnetic path 12A between the inner rotating portion 24C and the inner fixed portion 30C are inclined relative to the Z-axis direction (the axial direction of the rotor 20). For this reason, the restoring force F in the radial direction can be made to act on the rotor 20 such that the displacement of the rotor 20 in the radial direction can be eliminated and the radial direction position of the rotor 20 can be stabilized. Because of this, even in a case where, for example, the rotational speed of the rotor 20 is large, displacement of the rotor 20 in the radial direction can be appropriately inhibited.

Moreover, the one-side surface of the outer rotating portion 24B of the rotor 20 and the other-side surface of the outer fixed portion 30B of the one-side stator 30 are surfaces perpendicular to the Z-axis, and the other-side surface of the outer fixed portion 30B is disposed along the one-side surface of the outer rotating portion 24B. In addition, the one-side surface of the inner rotating portion 24C of the rotor 20 and the other-side surface of the inner fixed portion 30C of the one-side stator 30 are surfaces perpendicular to the Z-axis, and the other-side surface of the inner fixed portion 30C is disposed along the one-side surface of the inner rotating portion 24C. For this reason, the attraction force between the outer rotating portion 24B and the outer fixed portion 30B and the attraction force between the inner rotating portion 24C and the inner fixed portion 30C can be increased. Additionally, when the rotor 20 has become displaced in the radial direction, the restoring force F in the radial direction acting on the rotor 20 can be increased such that the displacement of the rotor 20 in the radial direction can be effectively eliminated.

Furthermore, the outer rotating portion 24B and the inner rotating portion 24C of the rotor 20 and the outer fixed portion 30B and the inner fixed portion 30C of the one-side stator 30 are provided in the entire circumferential direction of the rotor 20, and the attracting magnetic paths 12A between the rotor 20 and the one-side stator 30 are formed in the entire circumferential direction of the rotor 20. For this reason, the attraction force between the rotor 20 and the one-side stator 30 can be increased. Additionally, when the rotor 20 has become displaced in the radial direction, the restoring force F in the radial direction acting on the rotor 20 can be increased such that the displacement of the rotor 20 in the radial direction can be effectively eliminated.

Moreover, the rotor 20 is provided with the outer rotating portion 24B and the inner rotating portion 24C, the one-side stator 30 is provided with the outer fixed portion 30B and the inner fixed portion 30C, and the attracting magnetic paths 12A are formed in two places in the radial direction of the rotor 20. For this reason, the attraction force between the rotor 20 and the one-side stator 30 can be increased. Additionally, when the rotor 20 has become displaced in the radial direction, the restoring force F in the radial direction acting on the rotor 20 can be increased such that the displacement of the rotor 20 in the radial direction can be effectively eliminated.

Furthermore, in the magnetic levitation motor 10, an impeller (not shown) is provided in the rotor 20 (e.g., between the rotating body 24 and the rotor magnets 22), so the impeller can be rotated integrally with the rotor 20 to pump fluids. For this reason, the magnetic levitation motor 10 can be used as a pump, and the magnetic levitation motor 10 can be applied to artificial hearts and the like. Because of this, the configuration of a pump such as an artificial heart that is the magnetic levitation motor 10 can be simplified and the pump can be reduced in size.

### First Example Modification

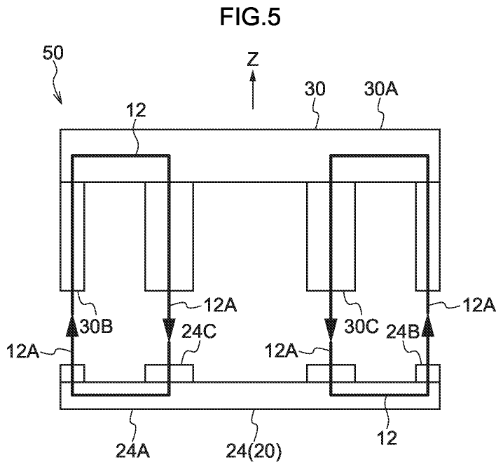

In FIG. 5, the one-side stator 30 and the rotating body 24 of the rotor 20 in a magnetic levitation motor 50 pertaining to an example modification of the first embodiment of the present invention are shown in a cross-sectional view.

As shown in FIG. 5, in the magnetic levitation motor 50 pertaining to the present example modification, in the one-side stator 30 the outer fixed portion 30B is a permanent magnet serving as an attracting permanent magnet, and the outer fixed portion 30B and the inner fixed portion 30C form a magnetic path 12 passing in the axial direction of the inner fixed portion 30C, the radial direction of the fixed plate 30A, and the axial direction of the outer fixed portion 30B.

In the rotating body 24 of the rotor 20, the outer rotating portion 24B and the inner rotating portion 24C are permanent magnets serving as attracting permanent magnets, and the outer rotating portion 24B and the inner rotating portion 24C form a magnetic path 12 passing in the axial direction of the inner rotating portion 24C, the radial direction of the rotating plate 24A, and the axial direction of the outer rotating portion 24B.

The magnetic path 12 formed by the outer fixed portion 30B and the inner fixed portion 30C and the magnetic path 12 formed by the outer rotating portion 24B and the inner rotating portion 24C are continuous between the one-side surface of the inner rotating portion 24C and the other-side surface of the inner fixed portion 30C and between the one-side surface of the outer rotating portion 24B and the other-side surface of the outer fixed portion 30B, such that an attraction force toward the other-side surface of the inner fixed portion 30C acts on the one-side surface of the inner rotating portion 24C and an attraction force toward the other-side surface of the outer fixed portion 30B acts on the one-side surface of the outer rotating portion 24B.

Here, in the present example modification also, the same action and effects as those of the first embodiment can be achieved.

Moreover, not only the inner fixed portion 30C of the one-side stator 30 but also the outer fixed portion 30B of the one-side stator 30 and the outer rotating portion 24B and the inner rotating portion 24C of the rotor 20 are permanent magnets. For this reason, the attraction force between the rotor 20 and the one-side stator 30 can be effectively increased. Additionally, when the rotor 20 has become displaced in the radial direction, the restoring force F in the radial direction acting on the rotor 20 can be effectively increased such that the displacement of the rotor 20 in the radial direction can be effectively eliminated.

### Second Embodiment

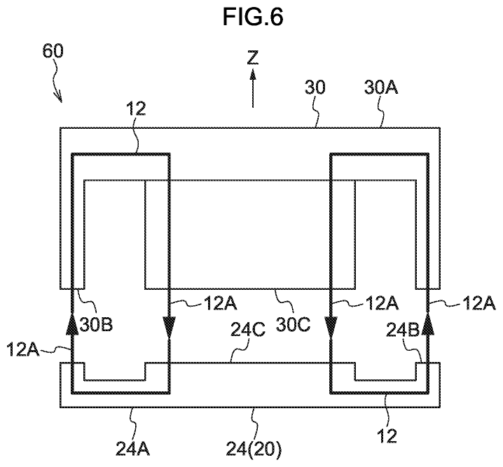

In FIG. 6, the one-side stator 30 and the rotating body 24 of the rotor 20 in a magnetic levitation motor 60 pertaining to a second embodiment of the present invention are shown in a cross-sectional view.

The magnetic levitation motor 60 pertaining to the present embodiment has substantially the same configuration as that of the first embodiment but differs in the following respects.

As shown in FIG. 6, in the magnetic levitation motor 60 pertaining to the present embodiment, in the one-side stator 30 the inner fixed portion 30C is formed in the shape of a closed cylinder, and the area of the other-side surface of the inner fixed portion 30C is large compared with the area of the other-side surface of the outer fixed portion 30B.

In the rotating body 24 of the rotor 20, the inner rotating portion 24C is formed in the shape of a closed cylinder, and the diameter of the inner rotating portion 24C is identical to the diameter of the inner fixed portion 30C of the one-side stator 30.

Here, in the present embodiment also, the same action and effects as those of the first embodiment can be achieved.

Moreover, the inner fixed portion 30C of the one-side stator 30 and the inner rotating portion 24C of the rotor 20 are formed in the shapes of closed cylinders, and the areas of the other-side surface of the inner fixed portion 30C and the one-side surface of the inner rotating portion 24C are large. For this reason, the attraction force between the rotor 20 and the one-side stator 30 can be effectively increased. Additionally, when the rotor 20 has become displaced in the radial direction, the restoring force F in the radial direction acting on the rotor 20 can be effectively increased such that the displacement of the rotor 20 in the radial direction can be effectively eliminated.

### Second Example Modification

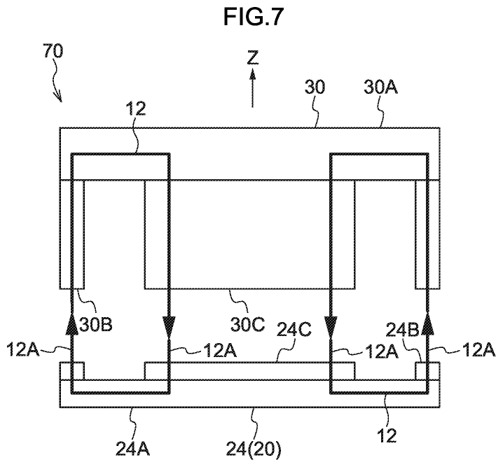

In FIG. 7, the one-side stator 30 and the rotating body 24 of the rotor 20 in a magnetic levitation motor 70 pertaining to an example modification of the second embodiment of the present invention are shown in a cross-sectional view.

As shown in FIG. 7, in the magnetic levitation motor 70 pertaining to the present example modification, in the one-side stator 30 the outer fixed portion 30B is a permanent magnet serving as an attracting permanent magnet, and the outer fixed portion 30B and the inner fixed portion 30C form a magnetic path 12 passing in the axial direction of the inner fixed portion 30C, the radial direction of the fixed plate 30A, and the axial direction of the outer fixed portion 30B.

In the rotating body 24 of the rotor 20, the outer rotating portion 24B and the inner rotating portion 24C are permanent magnets serving as attracting permanent magnets, and the outer rotating portion 24B and the inner rotating portion 24C form a magnetic path 12 passing in the axial direction of the inner rotating portion 24C, the radial direction of the rotating plate 24A, and the axial direction of the outer rotating portion 24B.

The magnetic path 12 formed by the outer fixed portion 30B and the inner fixed portion 30C and the magnetic path 12 formed by the outer rotating portion 24B and the inner rotating portion 24C are continuous between the one-side surface of the inner rotating portion 24C and the other-side surface of the inner fixed portion 30C and between the one-side surface of the outer rotating portion 24B and the other-side surface of the outer fixed portion 30B, such that an attraction force toward the other-side surface of the inner fixed portion 30C acts on the one-side surface of the inner rotating portion 24C and an attraction force toward the other-side surface of the outer fixed portion 30B acts on the one-side surface of the outer rotating portion 24B.

Here, in the present example modification also, the same action and effects as those of the second embodiment can be achieved.

Moreover, not only the inner fixed portion 30C of the one-side stator 30 but also the outer fixed portion 30B of the one-side stator 30 and the outer rotating portion 24B and the inner rotating portion 24C of the rotor 20 are permanent magnets. For this reason, the attraction force between the rotor 20 and the one-side stator 30 can be effectively increased. Additionally, when the rotor 20 has become displaced in the radial direction, the restoring force F in the radial direction acting on the rotor 20 can be effectively increased such that the displacement of the rotor 20 in the radial direction can be effectively eliminated.

### Third Embodiment

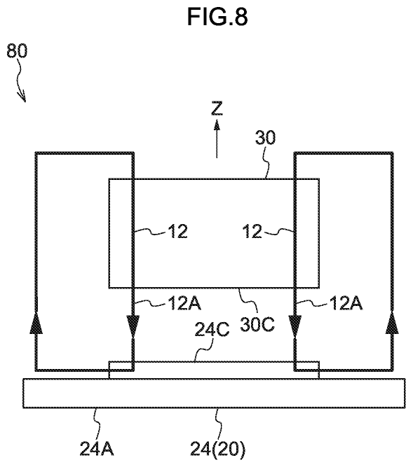

In FIG. 8, the one-side stator 30 and the rotating body 24 of the rotor 20 in a magnetic levitation motor 80 pertaining to a third embodiment of the present invention are shown in a cross-sectional view.

The magnetic levitation motor 80 pertaining to the present embodiment has substantially the same configuration as that of the second embodiment but differs in the following respects.

As shown in FIG. 8, in the magnetic levitation motor 80 pertaining to the present embodiment, the one-side stator 30 is not provided with the fixed plate 30A and the outer fixed portion 30B, and the inner fixed portion 30C forms a magnetic path 12 passing in the axial direction of the inner fixed portion 30C.

The rotating body 24 of the rotor 20 is not provided with the outer rotating portion 24B, and the rotating plate 24A is a non-magnetic body. The magnetic path 12 formed by the inner fixed portion 30C of the one-side stator 30 passes between the other-side surface of the inner fixed portion 30C and the one-side surface of the inner rotating portion 24C and in the radial direction of the inner rotating portion 24C.

Here, in the present embodiment also, the same action and effects as those of the second embodiment can be achieved.

Moreover, the one-side stator 30 is not provided with the fixed plate 30A and the outer fixed portion 30B, and the rotating body 24 of the rotor 20 is not provided with the outer rotating portion 24B. For this reason, the configuration of the magnetic levitation motor 80 can be simplified even more, and the magnetic levitation motor 80 can be reduced in size even more.

It will be noted that in the present embodiment the inner rotating portion 24C of the rotor 20 (the rotating body 24) may be a permanent magnet serving as an attracting permanent magnet.

### Fourth Embodiment

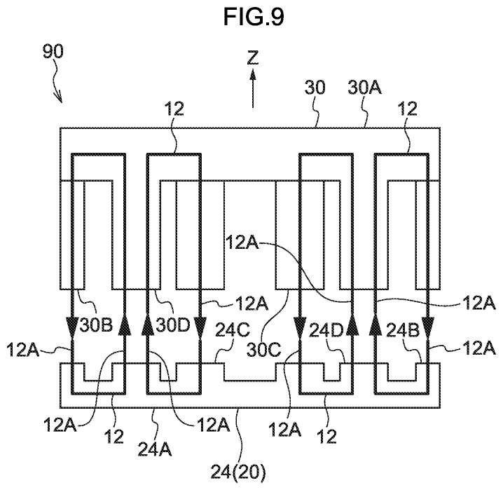

In FIG. 9, the one-side stator 30 and the rotating body 24 of the rotor 20 in a magnetic levitation motor 90 pertaining to a fourth embodiment of the present invention are shown in a cross-sectional view.

The magnetic levitation motor 90 pertaining to the present embodiment has substantially the same configuration as that of the first embodiment but differs in the following respects.

As shown in FIG. 9, in the magnetic levitation motor 90 pertaining to the present embodiment, an open cylinder-shaped middle fixed portion 30D serving as a fixed opposing portion is integrally and coaxially provided between the outer fixed portion 30B and the inner fixed portion 30C on the fixed plate 30A of the one-side stator 30, and the middle fixed portion 30D projects toward the other side and its other-side surface is formed in a planar shape perpendicular to the Z-axis. The outer fixed portion 30B of the one-side stator 30 is a permanent magnet serving as an attracting permanent magnet, and the outer fixed portion 30B forms a magnetic path 12 passing in the axial direction of the outer fixed portion 30B, the radial direction of the fixed plate 30A, and the axial direction of the middle fixed portion 30D. Moreover, the inner fixed portion 30C forms a magnetic path 12 passing in the axial direction of the inner fixed portion 30C, the radial direction of the fixed plate 30A, and the axial direction of the middle fixed portion 30D.

In the rotating body 24 of the rotor 20, an open cylinder-shaped middle rotating portion 24D serving as a rotating opposing portion is integrally and coaxially provided between the outer rotating portion 24B and the inner rotating portion 24C on the rotating plate 24A, and the middle rotating portion 24D projects toward the one side and its one-side surface is formed in a planar shape perpendicular to the axial direction of the rotor 20. The outer diameter and inner diameter of the middle rotating portion 24D are identical to the outer diameter and inner diameter of the middle fixed portion 30D of the one-side stator 30, respectively, and the one-side surface of the middle rotating portion 24D opposes the other-side surface of the middle fixed portion 30D of the one-side stator 30.

The magnetic path 12 formed by the outer fixed portion 30B of the one-side stator 30 passes between the one-side surface of the outer rotating portion 24B and the other-side surface of the outer fixed portion 30B and in the radial direction of the rotating plate 24A and between the one-side surface of the middle rotating portion 24D and the other-side surface of the middle fixed portion 30D, and the magnetic path 12 formed by the inner fixed portion 30C of the one-side stator 30 passes between the one-side surface of the inner rotating portion 24C and the other-side surface of the inner fixed portion 30C and in the radial direction of the rotating plate 24A and between the one-side surface of the middle rotating portion 24D and the other-side surface of the middle fixed portion 30D. Furthermore, a magnetic path 12 passes between the one-side surface of the inner rotating portion 24C and the other-side surface of the inner fixed portion 30C such that an attraction force toward the other-side surface of the inner fixed portion 30C acts on the one-side surface of the inner rotating portion 24C, a magnetic path 12 passes between the one-side surface of the outer rotating portion 24B and the other-side surface of the outer fixed portion 30B such that an attraction force toward the other-side surface of the outer fixed portion 30B acts on the one-side surface of the outer rotating portion 24B, and a magnetic path 12 passes between the one-side surface of the middle rotating portion 24D and the other-side surface of the middle fixed portion 30D such that an attraction force toward the other-side surface of the middle fixed portion 30D acts on the one-side surface of the middle rotating portion 24D. Because of this, an attraction force toward the one side and the Z-axis side acts on the rotor 20.

Here, in the present embodiment also, the same action and effects as those of the first embodiment can be achieved.

Moreover, not only the inner fixed portion 30C of the one-side stator 30 but also the outer fixed portion 30B of the one-side stator 30 are permanent magnets. For this reason, the attraction force between the rotor 20 and the one-side stator 30 can be effectively increased. Additionally, when the rotor 20 has become displaced in the radial direction, the restoring force F in the radial direction acting on the rotor 20 can be effectively increased such that the displacement of the rotor 20 in the radial direction can be effectively eliminated.

In addition, the rotor 20 is provided with not only the outer rotating portion 24B and the inner rotating portion 24C but also the middle rotating portion 24D, the one-side stator 30 is provided with not only the outer fixed portion 30B and the inner fixed portion 30C but also the middle fixed portion 30D, and the attracting magnetic paths 12A are formed in three places in the radial direction of the rotor 20. For this reason, the attraction force between the rotor 20 and the one-side stator 30 can be effectively increased. Additionally, when the rotor 20 has become displaced in the radial direction, the restoring force F in the radial direction acting on the rotor 20 can be effectively increased such that the displacement of the rotor 20 in the radial direction can be effectively eliminated.

### Third Example Modification

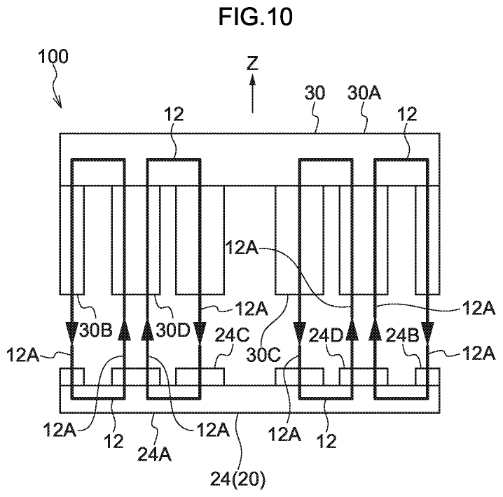

In FIG. 10, the one-side stator 30 and the rotating body 24 of the rotor 20 in a magnetic levitation motor 100 pertaining to an example modification of the fourth embodiment of the present invention are shown in a cross-sectional view.

As shown in FIG. 10, in the magnetic levitation motor 100 pertaining to the present example modification, in the one-side stator 30 the middle fixed portion 30D is a permanent magnet serving as an attracting permanent magnet, the outer fixed portion 30B and the middle fixed portion 30D form a magnetic path 12 passing in the axial direction of the outer fixed portion 30B, the radial direction of the fixed plate 30A, and the axial direction of the middle fixed portion 30D, and the inner fixed portion 30C and the middle fixed portion 30D form a magnetic path 12 passing in the axial direction of the inner fixed portion 30C, the radial direction of the fixed plate 30A, and the axial direction of the middle fixed portion 30D.

In the rotating body 24 of the rotor 20, the outer rotating portion 24B, the inner rotating portion 24C, and the middle rotating portion 24D are permanent magnets serving as attracting permanent magnets, the outer rotating portion 24B and the middle rotating portion 24D form a magnetic path 12 passing in the axial direction of the outer rotating portion 24B, the radial direction of the rotating plate 24A, and the axial direction of the middle rotating portion 24D, and the inner rotating portion 24C and the middle rotating portion 24D form a magnetic path 12 passing in the axial direction of the inner rotating portion 24C, the radial direction of the rotating plate 24A, and the axial direction of the middle rotating portion 24D.

The magnetic path 12 formed by the outer fixed portion 30B and the middle fixed portion 30D and the magnetic path 12 formed by the outer rotating portion 24B and the middle rotating portion 24D are continuous between the one-side surface of the outer rotating portion 24B and the other-side surface of the outer fixed portion 30B and between the one-side surface of the middle rotating portion 24D and the other-side surface of the middle fixed portion 30D, such that an attraction force toward the other-side surface of the outer fixed portion 30B acts on the one-side surface of the outer rotating portion 24B and an attraction force toward the other-side surface of the middle fixed portion 30D acts on the one-side surface of the middle rotating portion 24D. The magnetic path 12 formed by the middle fixed portion 30D and the inner fixed portion 30C and the magnetic path 12 formed by the middle rotating portion 24D and the inner rotating portion 24C are continuous between the one-side surface of the inner rotating portion 24C and the other-side surface of the inner fixed portion 30C and between the one-side surface of the middle rotating portion 24D and the other-side surface of the middle fixed portion 30D, such that an attraction force toward the other-side surface of the inner fixed portion 30C acts on the one-side surface of the inner rotating portion 24C and an attraction force toward the other-side surface of the middle fixed portion 30D acts on the one-side surface of the middle rotating portion 24D.

Here, in the present example modification also, the same action and effects as those of the fourth embodiment can be achieved.

Moreover, not only the outer fixed portion 30B and the inner fixed portion 30C of the one-side stator 30 but also the middle fixed portion 30D of the one-side stator 30 and the outer rotating portion 24B, the inner rotating portion 24C, and the middle rotating portion 24D of the rotor 20 are permanent magnets. For this reason, the attraction force between the rotor 20 and the one-side stator 30 can be effectively increased. Additionally, when the rotor 20 has become displaced in the radial direction, the restoring force F in the radial direction acting on the rotor 20 can be effectively increased such that the displacement of the rotor 20 in the radial direction can be effectively eliminated.

It will be noted that in the fourth embodiment (including the third example modification) the inner fixed portion 30C of the one-side stator 30 and the inner rotating portion 24C of the rotor 20 may also be formed in the shapes of closed cylinders.

Furthermore, in the first embodiment (including the first example modification), the second embodiment (including the second example modification), the third embodiment, and the fourth embodiment (including the third example modification), just the one-side stator 30 or the one-side stator 30 and the rotor 20 are provided with attracting permanent magnets. However, just the rotor 20 may be provided with attracting permanent magnets.

Moreover, in the first embodiment (including the first example modification), the second embodiment (including the second example modification), the third embodiment, and the fourth embodiment (including the third example modification), the other-side end portions of the fixed opposing portions (the outer fixed portion 30B, the inner fixed portion 30C, and the middle fixed portion 30D) of the one-side stator 30 may be pointed and the other-side ends of the fixed opposing portions may be formed in linear shapes, and the one-side end portions of the rotating opposing portions (the outer rotating portion 24B, the inner rotating portion 24C, and the middle rotating portion 24D) of the rotor 20 may be pointed and the one-side ends of the rotating opposing portions may be formed in linear shapes.

The disclosure of Japanese Patent Application No. 2022-57372 filed on Mar. 30, 2022, is incorporated in its entirety herein by reference.

### REFERENCE SIGNS LIST

10 Magnetic Levitation Motor
12A Attracting Magnetic Paths
20 Rotor
22 Rotor Magnet (Rotating Permanent Magnet)
24B Outer Rotating Portion (Rotating Opposing Portion, Attracting Permanent Magnet)
24C Inner Rotating Portion (Rotating Opposing Portion, Attracting Permanent Magnet)
24D Middle Rotating Portion (Rotating Opposing Portion, Attracting Permanent Magnet)
30 One-side Stator
30B Outer Fixed Portion (Fixed Opposing Portion, Attracting Permanent Magnet)
30C Inner Fixed Portion (Fixed Opposing Portion, Attracting Permanent Magnet)
30D Middle Fixed Portion (Fixed Opposing Portion, Attracting Permanent Magnet)
40 Other-side Stator
48 Coil
50 Magnetic Levitation Motor
60 Magnetic Levitation Motor
70 Magnetic Levitation Motor
80 Magnetic Levitation Motor
90 Magnetic Levitation Motor
100 Magnetic Levitation Motor

1. A magnetic levitation motor, comprising:
a rotor that is rotatable in a circumferential direction;
a one-side stator that is disposed at one side in an axial direction of the rotor;
an other-side stator that is disposed at another side in the axial direction of the rotor and that is provided with a coil;
a rotating permanent magnet that is provided at an axial direction other-side portion of the rotor and that is attracted to the other-side stator such that the rotor is attracted toward the other side in the axial direction, with magnetic flux generated by the coil being controlled such that the rotor is rotated; and
an attracting permanent magnet that is provided at at least one of an axial direction one-side portion of the rotor or the one-side stator such that an attracting magnetic path is formed between the rotor and the one-side stator, whereby the rotor is attracted toward the one side in the axial direction, and when the rotor has become displaced in a radial direction, the attracting magnetic path is inclined relative to the axial direction of the rotor.

2. The magnetic levitation motor of claim 1, further comprising:
a rotating opposing portion that is provided at the rotor; and
a fixed opposing portion that is provided at the one-side stator and that opposes the rotating opposing portion such that the attracting magnetic path is formed between the rotating opposing portion and the fixed opposing portion, and when the rotor has become displaced in the radial direction, at least part of opposition between the rotating opposing portion and the fixed opposing portion is canceled.

3. The magnetic levitation motor of claim 2, wherein an opposing surface of the fixed opposing portion that opposes the rotating opposing portion is disposed along an opposing surface of the rotating opposing portion that opposes the fixed opposing portion.

4. The magnetic levitation motor of claim 2, wherein at least one of the rotating opposing portion or the fixed opposing portion is formed in a tubular shape or a columnar shape.

5. The magnetic levitation motor of claim 2, wherein a distal end of at least one of the rotating opposing portion or the fixed opposing portion is pointed.

6. The magnetic levitation motor of claim 1, wherein the attracting magnetic path is formed at the entire circumferential direction of the rotor.

7. The magnetic levitation motor of claim 1, wherein a plurality of the attracting magnetic paths are formed at the radial direction of the rotor.

8. The magnetic levitation motor of claim 1, wherein a fluid is pumped by the rotation of the rotor.
